(19) United States
(12) Patent Application Publication
(10) Pub. No.: US 2025/0120414 A1
(43) Pub. Date: Apr. 17, 2025

(54) KENGER GUM ADDED SOFT CANDY PRODUCTION

(71) Applicant: TEKIRDAG NAMIK KEMAL ÜNIVERSITESI, Tekirdag (TR)

(72) Inventor: Ibrahim PALABIYIK, Tekirdag (TR)

(21) Appl. No.: 18/700,032

(22) PCT Filed: Dec. 21, 2022
(86) PCT No.: PCT/TR2022/051548

§ 371 Date: Apr. 10, 2024

(30) Foreign Application Priority Data
Mar. 18, 2022 (TR) 2022/004187

(51) Int. Cl. A23G 3/42; A23G 3/40

(52) U.S. Cl. CPC A23G 3/42; A23G 3/40

(57) ABSTRACT

The present invention relates to the food industry and relates to the use of Kenger gum as a structure (texturing) ingredient in the soft candy formulation in the candy industry, and to the production of Kenger gum added soft candy.

### FIELD OF THE INVENTION

The present invention relates to the food industry and relates to the use of Kenger gum as a structure (texturing) ingredient in the soft candy formulation in the candy industry, and to the production of Kenger gum added soft candy.

### STATE OF THE ART

The technical field of the invention is within the scope of product development and formulation renewal studies in the Candy Industry. The candy sector can be defined as a sector with a wide range of products that can appeal to consumer groups of all ages. It is possible to define the products produced in the sector as products that are consumed especially for the purpose of getting pleasure rather than the elimination of hunger. Said main products can be listed as follows; hard candies, soft candies, chocolate and its varieties, chewing gum and its varieties, coated and/or filled-unfilled products, dragees, fudge and fondant. Soft candies in the product portfolio are intensively produced and consumed by large masses in said sector. Soft and chewy candy also has a wide variety of forms, today, many different products can be produced depending on the changes made in the formulation and production process. However, despite all this diversity, sucrose, glucose syrup, various vegetable oils, color and flavoring agents, and different hydrocolloids, especially gelatin, are used as gelling agents in soft candy production.

Although there are many different methods in the soft candy production process, the cooking process is usually carried out at a high temperature such as 120-135° C., the cooking process is continued until the moisture and brix value of the mixture reaches the appropriate value according to the product type. The slightest change in temperature in said process has a great importance on the quality of the final product. Along with the cooking process, the gelatin used in the product recipe has an important functionality in terms of both the structure of the final product and the preferred consumption characteristic of the soft candy. Today, different hydrocolloids are used instead of gelatin, which is used in soft candies at different rates depending on the type. However, although the type of hydrocolloid used in the formulation changes, there is not much change in the duration of the process with the high cooking temperature in the process. In this regard, the conventional methods used in the production of soft candy and the high temperature in the process limit the enrichment of such products in terms of various functional components that have an important role in human nutrition but are sensitive to heat. There are no patent, patent application, article, etc. publications in the literature on the use of Kenger gum with a new production method in soft candy formulation.

When the patents related to aforementioned subject are taken into consideration, the following explanation has been deemed appropriate so as to avoid confusion.

The patent numbered 2016/20317, which can be seen in the research, relates to “GUM” which is a food product having a method to improve the chewability properties of Kenger gum and to produce biodegradable natural gum from Kenger. As mentioned in the Turkish Food Codex Gum Declaration (Declaration No: 99/4), chewing gum with a classical and simple definition comprises of the gum base, other ingredients, permitted additives and flavorings, and products prepared with or without sugar in accordance with its method. There are two phases that dissolve in the mouth and insoluble in the mouth in the structure of the gum. The insoluble part of the gum is composed of gum base; it contains food-grade elastomer, resin, vinyl polymer, paraffin, microcrystalline wax, vegetable oil and products prepared in accordance with the method with permitted additives. Gum base, which gives the gum a special product characteristic, is produced synthetically in the mouth today, it is a component that does not melt in the mouth after chewing, does not disperse and therefore cannot be swallowed.

After this simple definition of chewing gum, the new invention “Kenger Gum Added Soft Candy Production” covers soft candies that are “completely dispersed and swallowed in the mouth after chewing”, completely different from chewing gum. For this reason, there is no similarity between the two products in terms of product definition, structure and consumption.

The usage rate of Kenger Gum in soft candy is limited to a maximum of 2% in our aforementioned patent. Kenger gum literally replaces hydrocolloids such as gelatin, pectin, starch used in soft candy at this rated and below this rate. Once this rate is exceeded, the soft candies produced do not comply with the product definition and the product transforms into chewing gum. This situation is certainly not present in the state of the art. The usage rate of Kenger Gum in the production of biodegradable natural gum is much higher than 2% in the patent file numbered 2016/20317. Thus, since Kenger Gum itself is a gum, it is clear that more than 2% is required for it to be used in chewing gum formulation. Since gum base depends on the type of gum in conventional chewing gums produced today, it is 20% or more.

In addition to all these, many tools are used together in the production of classical soft candy, as shown in the diagram in the article named sugar, soft candy and sugary products, which can also be revealed in the scanning of the subject. (https://doczz.biz.tr/doc/110967/%C5%9Fekerli-%C3%BCr%C3%BCnler-adem-elq%C3%BCn) These include cooking pots, mixers, and coolers, drawing machines or beaters. However, this complex equipment list is not required with the use of Kenger Gum in the formulation, and for the first time, using the Gum Mixer (a picture of the device is given in the patent application file), it is possible to produce products with the desired textural properties in “one step” in the production of soft candy with said new patent, this application is also unique in this respect.

After mixing the syrup prepared with water, sugar, glucose syrup and the gelatin solution used as a gelling agent in conventional soft candy production, in order to reach the desired Brix value, that is, to evaporate excess water, the soft candy mixture is cooked at high temperatures (120-135° C.) (FIG. 1). The use of high temperature in production limits the enrichment of soft candy products, which are widely consumed, with some functional additives that are necessary for the body but are sensitive to high heat treatments. On the other hand, reducing the dough temperature to temperatures such as 55-60° C., where the mixing process can be continued relatively after the baking process, both prevents the homogeneous distribution of the substances that are planned to be added to the product due to its high viscosity in the product dough and inhibits many bioactive components. In addition to all these, another problem arises since a certain group of consumers do not want to consume gelatin-added products, which are of animal origin and are most used in soft candies. For this reason, it is considered that it is very important to search for new formulation studies and production methods that will enable the production of functional soft candies in said sector, and new developments to be determined in this regard will bring new balances to the sector.

### DEFINITION OF THE INVENTION

Said invention eliminates the disadvantages described in the state of the art and fulfills the needs.

Said invention relates to the food industry and relates to the use of Kenger gum as a structure (texturing) ingredient in the soft candy formulation in the candy industry, and to the production of Kenger gum added soft candy.

Kenger gum was used instead of gelatin, which is widely used in soft candy formulation, a different production process is used instead of high heat treatment, and functional product production is achieved in the relevant product group with the present invention.

The field where the invention can be applied is the places that produce soft candy in the soft candy sector.

In said invention proposal, Kenger gum, a herbal latex obtained from the Kenger plant (Gundelia tournefortii L.) will be used instead of classical hydrocolloids in the product formulation, all the ingredients in the sugary and sugar-free product recipe, which are optimized different from the classical production process are mixed in one go and brought to the appropriate humidity value (5-6%) in a short time like 40 minutes at a constant temperature (120° C.) and thus the production of a brand new soft candy product is made available. In this way, the product is produced in the gum mixer with the new method, soft candy dough can be produced after the cooking process at 120° C. in as little as 40 minutes by mixing the raw materials in the optimized recipe in one go without preparing any syrup beforehand. After the main dough production, the addition of various functional components can be easily applied to the soft candy dough at 35-40° C., which will allow the dough to be mixed in the gum mixer. In brief, it can be said that there is no stage to reach the desired Brix value by evaporating the excess water with the cooking process at high temperatures in the production method presented in the invention proposal compared to the conventional process. On the other hand, the production method described in the invention is advantageous in terms of time and energy savings when compared to classical methods. In the new method, there is no need for any extra labor, waiting place and time to ripen the candies after production. In this respect, the production of soft candy will be brought to the industry in a continuous manner with an uninterrupted process with the new production line to be designed in the enterprises. Gelatin, which is widely used in product formulation, will be replaced with a herbal source (Kenger gum) with the new method, thus, consumers who do not want to consume gelatin-added products can be included in the customer portfolio and apart from these, a new page will be opened in the functionality studies in soft candy products with said invention.

### BRIEF DESCRIPTION OF DRAWINGS

FIG. 1. Conventional soft type candy production work flow chart

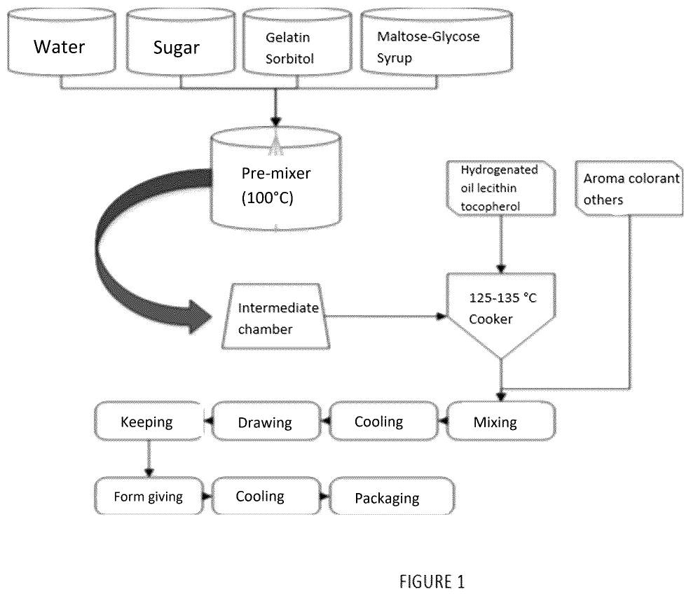

FIG. 2. Inventive Kenger gum added soft candy production process

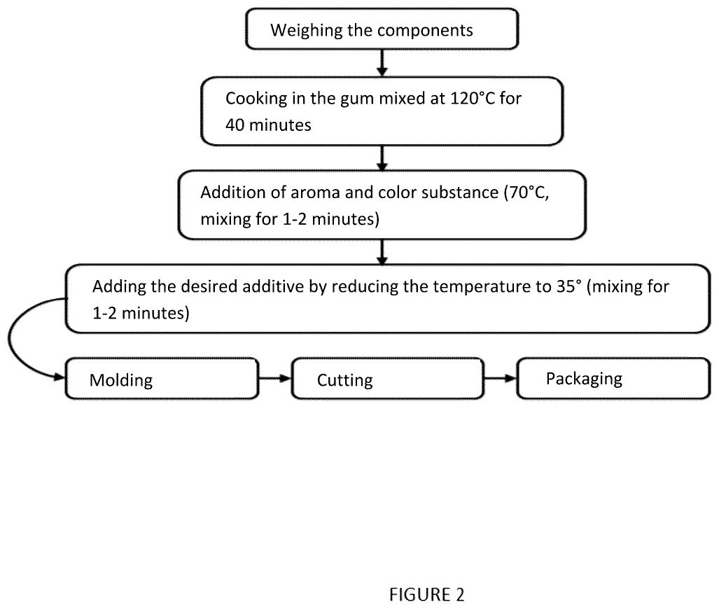

### DESCRIPTION OF THE INVENTION

The present invention is the Kenger gum added soft candy production.

Kenger gum is a product formed as a result of the gum-like consistent and white colored liquid that is released when the roots and leaves of the Gundelia tournefortii L. plant, which grows spontaneously in nature, acquires a hard structure when retained. Said product is completely natural and of herbal origin, and it can be chewed like gum in its first form Furthermore, Kenger gum softens depending on the temperature and acts as a binder and binding agent in the formulation, and serves as a filling material. In this regard, it exhibits properties similar to gelatin and other hydrocolloids, which give softness, flexibility and chewiness to the final product, especially in soft candy production. On the other hand, Squalen (olive oil origin), a natural organic compound used in the formulation we optimized, provides full oral dispersibility of Kenger gum which is a polymer in latex form. Said component is also added to the formulation to soften the product and remove stickiness, it also contributes to the functionality of the product produced with its features. In addition to all these, the formulation content of both sugar and sugar-free soft candies with Kenger gum added in the present invention proposal is quite simple, it does not contain many additives that classical products contain. Powdered sugar was completely removed and various polyols were used instead in the optimized Kenger gum added sugar-free soft candy product formulation, and thus the production of 0% sugar-free products was made possible. In this regard, there are no similar/alternative compositions and applications that can be applied apart from the present composition in our invention.

The new soft candy production process in our invention is as follows;
Weighing all raw materials according to the optimized recipe and putting them in the gum mixer,.
Starting the cooking process by adjusting the temperature to 120° C.,
Continuing the cooking process at 120° C. for 40 minutes,.
Reducing the temperature to 70° C., adding flavoring and coloring matter and continuing to mix for 1-2 minutes after the cooking process,
Reducing the temperature to 35-40° C. according to the product planned to be produced and adding the desired functional additive(s) and continuing mixing for 1-2 minutes,
Taking the soft candy dough from the mixer and molding the same,
Weighting and packaging of the molded soft candy dough by cutting the same in desired sizes and dimensions.

The formulation content of both sugar and sugar-free soft candies containing Kenger gum is put forward in said invention proposal.

Powdered Sugar, Glucose Syrup, Ground Kenger Gum, Squalene are used in the formulation of Kenger gum added sugary soft candy. It can also be added in flavoring. In this formulation, 45-50% (preferably 46.72%) Powdered Sugar, 45-50% (preferably 48.92%) Glucose Syrup, 2-3% (preferably 2.16%) Ground Kenger Gum, 2-3% (preferably 2% Squalene and if used, 0.1-0.3% flavor (preferably 0.2%) can be used.

The following Kenger gum-added sugar-free soft candy formulation can be created by completely removing the powdered sugar and replacing the same with various polyols in the optimized Kenger gum-added sugar-free soft candy product formulation. In this formulation; 2-3% (preferably 2%) Ground Kenger Gum, 55-56% (preferably 55.81) isomalt, 15-16% (preferably 15) Powder Sorbitol, 19-21% (preferably 20%) Maltitol Syrup, 4% −6 (preferably 5%) Xylitol, 2-3% (preferably 2%) Squalene and, if used, 0.1-0.3% (preferably 0.2%) aroma can be used.

1. Kenger gum added soft candy, characterized in that; it contains 2-3% ground Kenger Gum and 2-3% Squalene.

2. Kenger gum added soft candy according to claim 1, characterized in that; it contains 2% ground Kenger Gum and 2% Squalene.

3. Kenger gum added soft candy according to claim 1, characterized in that; it contains 2-3% ground Kenger Gum and 2-3% Squalene, as well as 45-50% Powdered Sugar, 45-50% Glucose Syrup, 0.1-0.3% aroma in sugary production.

4. Kenger gum added soft candy according to claim 1, characterized in that; it contains 2,16% ground Kenger Gum and preferably 2% Squalene, preferably 46.72% Powdered Sugar, preferably 48.92% Glucose Syrup, if used preferably 0,2% aroma in sugary production.

5. Kenger gum added soft candy according to claim 1, characterized in that; it contains 2-3% ground Kenger Gum and 2-3% Squalene, as well as 55-56% Isomalt, 15-16% Powdered Sorbitol, 19-21% Maltitol Syrup, 4-6% Xylitol 2-3% Squalene and if used, 0.1-0.3% aroma in sugar-free production.

6. Kenger gum added soft candy according to claim 1, characterized in that; it contains 2% ground Kenger Gum and 2% Squalene, preferably 55.81 Isomalt, 15% Powder Sorbitol, preferably 20% Maltitol Syrup, preferably 5% Xylitol, preferably 2% Squalene is and if used, 0.2% aroma in sugary production.
